(19) United States
(12) Patent Application Publication
(10) Pub. No.: US 2012/0151931 A1
(43) Pub. Date: Jun. 21, 2012

(54) Distributed Ignition Of Fuels Using Nanoparticles

(75) Inventors: Xiaolin Zheng, Stanford, CA (US); Yuma Ohkura, Stanford, CA (US)

(73) Assignee: The Board of Trustees of the Leland Stanford Junior University, Palo Alto, CA (US)

(21) Appl. No.: 13/325,869

(22) Filed: Dec. 14, 2011

Related U.S. Application Data
(60) Provisional application No. 61/459,563, filed on Dec. 15, 2010.

(51) Int. Cl. F02M 57/00; F23Q 7/06

(52) U.S. Cl. 60/746; 431/258

(57) ABSTRACT

An engine includes: (1) a housing defining a combustion chamber; (2) a set of injection mechanisms connected to the housing and configured to introduce a fuel and nanoparticles into the combustion chamber; and (3) an optical ignition system connected to the housing and configured to irradiate the nanoparticles to ignite the fuel.

### CROSS REFERENCE TO RELATED APPLICATION

This application claims the benefit of U.S. Provisional Application No. 61/459,563, filed on Dec. 15, 2010, the disclosure of which is incorporated herein by reference in its entirety.

### STATEMENT REGARDING FEDERALLY SPONSORED RESEARCH OR DEVELOPMENT

This invention was made with government support of Grant No. W911NF-10-1-0106, awarded by the Army Research Office. The Government has certain rights in this invention.

### BACKGROUND

Combustion of fuels provides a driving force for a number of applications, including stationary power generation and transportation. Fuels are typically ignited by spark plugs, hot wires, and pilot flames, where chemical reactions are initiated locally and propagate to the rest of a fuel volume. Since ignition occurs at a single location, incomplete combustion can occur when there is insufficient time for reaction, such as in rockets and scramjets. In addition, combustion of fuels is desirable to generate power in Microelectro mechanical systems (“MEMS”), but the limited space available impedes the use of conventional ignition systems.

It is against this background that a need arose to develop the technique for distributed ignition of fuels and related systems and methods described herein.

### SUMMARY

Distributed, non-intrusive, and miniaturizable ignition systems are desired for controlling combustion, and for allowing integration into MEMS as power generators. Embodiments described herein are directed to a distributed, optical ignition technique that uses an optical source to ignite nanostructures, resulting in the ignition of solid phase energetic materials, liquid fuels, and gaseous fuels. In some embodiments, the optical ignition occurs when the nanostructures have suitable dimensions and sufficient packing density to cause a temperature rise above their ignition temperatures. Transmission Electron Microscopy analysis provides experimental evidence that the nanostructures are oxidized via a melt-dispersion mechanism.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a reciprocating engine implemented in accordance with an embodiment of the invention.

FIG. 2 illustrates a jet engine implemented in accordance with another embodiment of the invention.

FIG. 3 illustrates a reaction device implemented in accordance with yet another embodiment of the invention.

FIG. 4: Flash ignition of Al nanoparticles and their thermite mixture with CuO nanoparticles. (a) Schematic and (b) optical images of the experimental setup for ignition of Al nanoparticles (d_{avg}=60-96 nm) by a camera flash unit. Inset: photograph of the burning of flash ignited Al nanoparticles, which cast a yellow glow and last for about 10 s. (c) Photographs of the burning process of a thermite mixture of Al and CuO nanoparticles ignited by a flash unit.

FIG. 5: Comparison of Al nanoparticles and Al/CuO thermite mixture before and after exposure to a camera flash. (a-c) Optical and Scanning Electron Microscopy (“SEM”) images of Al nanoparticles before and after the exposure. The original spherical Al nanoparticles break up into smaller clusters after burning. (d-f) Optical and SEM images of Al/CuO nanoparticles before and after the exposure. The products of thermite reaction agglomerated into much larger, micron-sized particles.

FIG. 6: Estimated temperature rise of Al particles by a flash exposure as a function of the Al particle diameter for different packing densities. The maximum temperature rise occurs at d=75 nm. Inset: The temperature rise of Al nanoparticles with a diameter of 70 nm as a function of the packing density of Al nanoparticles. The final temperature rise of Al nanoparticles with a diameter of 70 nm is less than 1 K for an isolated particle, but above 1,100 K when the packing density is above 1%.

FIG. 7: Exposure of Al nanoparticles to a flash unit in Ar. (a) Transmission Electron Microscopy (“TEM”) image of the Al nanoparticles before flash exposure. Inset: the Al nanoparticle is covered by an alumina shell about 2 nm thick. (b and c) TEM images of two different sizes of Al nanoparticles after flash exposure in Ar showing that both alumina shells have ruptured after the flash exposure.

FIG. 8: Exposure of Al nanoparticles to a flash unit in air and the melt-dispersion mechanism of Al oxidation. (a-e) Schematics and (f-i) TEM images illustrate the oxidation process of the Al nanoparticles. (a) Initial Al nanoparticles are covered by an Al₂O₃ shell. (b and f) Al melts upon rapid heating which pushes the shell outwardly. (c and g) The shell ruptures, and the melted Al comes in contact with air. (d and i) The large hollow sphere corresponds to the expanded Al nanoparticles, where most Al has moved away from the particle center and has been oxidized at the particle surface. (e and j) The hollow sphere fractures into small clusters of 3-20 nm in sizes. These clusters include both Al₂O₃ particles and partially oxidized Al particles.

### DETAILED DESCRIPTION

### Definitions

The following definitions apply to some of the aspects described with respect to some embodiments of the invention. These definitions may likewise be expanded upon herein.

As used herein, the singular terms “a,” “an,” and “the” include plural referents unless the context clearly dictates otherwise. Thus, for example, reference to an object can include multiple objects unless the context clearly dictates otherwise.

As used herein, the term “set” refers to a collection of one or more objects. Thus, for example, a set of objects can include a single object or multiple objects. Objects of a set can also be referred to as members of the set. Objects of a set can be the same or different. In some instances, objects of a set can share one or more common characteristics.

As used herein, the terms “connect,” “connected,” “connecting,” and “connection” refer to an operational coupling or linking. Connected objects can be directly coupled to one another or can be indirectly coupled to one another, such as through another set of objects.

As used herein, the term “nanometer range” or “nm range” refers to a range of dimensions less than about 1 micrometer (“μm”), such as from about 1 nm to about 999 nm. In some instances, the term can refer to a particular sub-range within the general range, such as from about 1 nm to about 100 nm, from about 1 nm to about 50 nm, from about 50 nm to about 100 nm, from about 1 nm to about 20 nm, from about 20 nm to about 100, from about 1 nm to about 10 nm, from about 10 nm to about 100 nm, from about 100 nm to about 200 nm, from about 100 nm to about 150 nm, from about 150 nm to about 200 nm, from about 200 nm to about 300 nm, from about 300 nm to about 400 nm, from about 400 nm to about 500 nm, from about 500 nm to about 600 nm, from about 600 nm to about 700 nm, from about 700 nm to about 800 nm, from about 800 nm to about 900 nm, and from about 900 nm to about 999 nm. The term can refer to other sub-ranges within the general range, such as no greater than about 900 nm, no greater than about 800 nm, no greater than about 700 nm, no greater than about 600 nm, no greater than about 500 nm, no greater than about 400 nm, no greater than about 300 nm, no greater than about 200 nm, or no greater than about 100 nm, and down to about 10 nm or down to about 1 nm.

As used herein, the term “aspect ratio” refers to a ratio of a largest dimension or extent of an object and an average of remaining dimensions or extents of the object, where the remaining dimensions are orthogonal with respect to one another and with respect to the largest dimension. In some instances, remaining dimensions of an object can be substantially the same, and an average of the remaining dimensions can substantially correspond to either of the remaining dimensions. For example, an aspect ratio of a cylinder refers to a ratio of a length of the cylinder and a cross-sectional diameter of the cylinder. As another example, an aspect ratio of a spheroid refers to a ratio of a major axis of the spheroid and a minor axis of the spheroid.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable characteristics that are substantially the same as those of the non-spherical object. Thus, for example, a size of a non-spherical object can refer to a diameter of a corresponding spherical object that exhibits optical characteristics that are substantially the same as those of the non-spherical object. Alternatively, or in conjunction, a size of a non-spherical object can refer to an average of various orthogonal dimensions of the object. Thus, for example, a size of an object that is a spheroidal can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

As used herein, the term “nanostructure” refers to an object that has at least one dimension in the nm range. A nanostructure can have any of a wide variety of shapes, and can be formed of a wide variety of materials.

As used herein, the term “nanoparticle” refers to a spherical or spheroidal nanostructure. Typically, each dimension of a nanoparticle is in the nm range, the nanoparticle has a size in the nm range, and the nanoparticle also has an aspect ratio that is less than about 5, such as no greater than about 3, no greater than about 2, no greater than about 1.5, or about 1.

As used herein, the term “ultraviolet range” refers to a range of wavelengths from about 5 nm to about 400 nm.

As used herein, the term “visible range” refers to a range of wavelengths from about 400 nm to about 700 nm.

As used herein, the term “infrared range” refers to a range of wavelengths from about 700 nm to about 2 mm.

### Distributed Ignition of Fuels

Embodiments described herein provide a technique to ignite solid, liquid, and gaseous fuels in a distributed, multi-point, or homogenous fashion for combustion applications. It is desirable to have distributed ignition to reduce the time for combustion and achieve higher combustion efficiency through greater uniformity of reaction. Shorter combustion time and higher combustion efficiency are desirable for a number of applications, including rapid reciprocating engines and jet engines.

According to some embodiments, a fuel and a set of nanoparticles are injected separately or as a mixture into a combustion chamber, and the nanoparticles are exposed to optical energy, such as a short pulse of light. The distribution of the nanoparticles within a volume of the fuel allows chemical reactions to be initiated at multiple locations. Specifically, the nanoparticles absorb the optical ener gy and release it as heat, and the released heat is sufficiently high to ignite the fuel in a distributed fashion.

According to some embodiments, the use of nanoparticles provides various advantages over other types of nanostructures. Certain of these advantages derive from a higher surface to volume ratio of nanoparticles, relative to nanostructures of other shapes, with the higher surface to volume ratio providing improved performance in terms of absorption of optical energy and its conversion into heat. Also, the use of nanoparticles allows ignition to occur without requiring an additional oxidant beyond air. Moreover, nanoparticles can be readily ignited, without relying on the presence of embedded catalysts that can translate into higher manufacturing and operational costs.

According to some embodiments, nanoparticles are formed of, or include, energetic materials having a high energy density that can be released as heat for ignition, such as an energy density of at least about 20 kJ/cm³, at least about 30 kJ/cm³, at least about 40 kJ/cm³, at least about 50 kJ/cm³, at least about 60 kJ/cm³, at least about 70 kJ/cm³, or at least about 80 kJ/cm³, and up to about 100 kJ/cm³, up to about 150 kJ/cm³, up to about 200 kJ/cm³, or more. Examples of such energetic materials include metals, such as alkali metals (e.g., lithium, sodium, potassium, rubidium, and cesium), alkaline earth metals (e.g., magnesium), transition metals (e.g., iron (“Fe”), copper (“Cu”), and molybdenum (“Mo”)), post-transition metals (e.g., aluminum (“Al”)), lanthanides, and actinides; and alloys, oxides, hydrides, and alkoxides of such metals, such as aluminum oxide (e.g., Al₂O₃), iron oxide (e.g., Fe₂O₃), copper oxide (e.g., CuO), and molybdenum oxide (e.g., MoO₃). Additional examples of such energetic materials include pyrophoric materials. According to some embodiments, nanoparticles each include a core that is formed of, or include, an energetic material, which core is partially or fully surrounded by a shell that is formed of, or includes, the same energetic material or a different material. A thickness of the shell can be up to about 20 nm, such as up to about 15 nm, up to about 10 nm, or up to about 5 nm, and down to about 1 nm or less. In some embodiments, the core is formed of, or includes, a metal, and the shell is formed of, or includes, an oxide of the same metal or a different metal. The shell can provide a protective function, as well as serve as an oxidant during ignition.

For example, Al has a high energy density of about 83.8 kJ/cm³, which is about twice as high as that of gasoline at 34.2 kJ/cm³. For micron-sized Al particles, their combustion process is similar to that of liquid droplet combustion (d² law), and their oxidation process occurs after the melting of an outer aluminum oxide shell. On the other hand, Al nanoparticles, compared to micron-sized Al particles, have a much lower ignition temperature (e.g., about 900 K or less) and faster burning rates (e.g., about 2,400 m/s or more). In view of the relative abundance of Al, the use of Al nanoparticles also provides cost advantages. The oxidation process of Al nanoparticles can proceed via two mechanisms: (1) a diffusion oxidation mechanism (“DOM”); and (2) a melt-dispersion mechanism (“MDM”). The DOM occurs when Al is heated with a relatively slow heating rate, such that Al and oxygen diffuse towards each other through a growing oxide shell. On the other hand, the MDM typically occurs at relatively fast heating rates (e.g., about 10⁶-10⁸ K/s), and postulates that the volume increase due to the melting of an Al core causes a buildup of large dynamic pressure within a nanoparticle. This high pressure ruptures an Al₂O₃ shell and generates an unloading pressure wave that propagates to the center of the nanoparticle and disperses the molten Al into small clusters at high velocity. In the Examples set forth below, an optical ignition technique is applied to Al nanoparticles to study their oxidization behavior at high heating rates, and observations indicate that Al nanoparticles are ignited by the MDM. Advantageously, optical ignition is applicable to the ignition of flammable gaseous, liquid, and solid materials by the addition of Al nanoparticles in lieu of co nventional ignition systems.

As another example, a mixture of nanoparticles formed of, or including, different energetic materials can be used. Specifically, the mixture of nanoparticles can correspond to a thermite mixture of a metal and a metal oxide that releases energy associated with highly exothermitc reduction/oxidation reactions to form a more stable oxide. Examples of such thermite mixtures include a mixture of Al nanoparticles and CuO nanoparticles, a mixture of Al nanoparticles and Fe₂O₃ nanoparticles, a mixture of Al nanoparticles and MoO₃ nanoparticles, as well as ternary, quaternary, and higher order mixtures of nanoparticles of metals and metal oxides.

According to some embodiments, nanoparticles are ignited by an optical source through a photo-thermal effect. Suitable optical sources include pulsed sources that provide an incident light intensity of at least about 100 W/cm², such as at least about 200 W/cm², at least about 300 W/cm², at least about 400 W/cm², at least about 500 W/cm², at least about 600 W/cm², at least about 700 W/cm², at least about 800 W/cm², at least about 900 W/cm², or at least about 1,000 W/cm², and up to about 1,500 W/cm², up to about 2,000 W/cm², up to about 3,000 W/cm², or more, on the basis of an energy density in the range of about 0.1 J/cm² to about 100 J/cm², such as from about 0.1 J/cm² to about 50 J/cm² or from about 0.1 J/cm² to about 10 J/cm², and a pulse duration in the range of about 0.1 ms to about 100 ms, such as from about 0.1 ms to about 50 ms or from about 0.1 ms to about 10 ms. Through the photo-thermal effect, irradiation of nanoparticles by an optical source can yield a heating rate in the range of about 10⁵ K/s to about 10⁹ K/s, such as from about 10⁵ K/s to about 10⁸ K/s, from about 10⁶ K/s to about 10⁸ K/s, or from about 10⁵ K/s to about 10⁷ K/s. For example, an electronic flashtube, such as a xenon lamp of a camera flash unit, can be a suitable optical source. Flash ignition has the advantages of low power input, multi-point initiation, and broad spectrum emission across the ultraviolet range, the visible range, and the infrared range. Since an absorption cross-section of nanoparticles typically peaks at different wavelengths for nanoparticles of different dimensions, a broad spectrum emission can be desirable to ignite the nanoparticles having different dimensions. A light-emitting diode that emits a short duration pulse also can be used as an optical source. Other embodiments can be implemented with an optical source that provides a substantially continuous light exposure to injected nanoparticles within a combustion chamber.

According to some embodiments, optical ignition is carried out through the use of nanoparticles having suitable dimensions in the nm range and a sufficiently high packing density, in order to yield a temperature rise at or above an ignition temperature of the nanoparticles. In some embodiments, nanoparticles desirably have a size (e.g., an average diameter by mass) that is no greater than about 500 nm, such as no greater than about 400 nm, no greater than about 300 nm, no greater than about 200 nm, or no greater than about 100 nm, and down to about 10 nm or down to about 1 nm. A packing density of nanoparticles can be specified as φ=V_{particles}/V_{Total}−V_{particles}, where V_{particles} represents a volume of the nanoparticles, V_{Total} represents a total volume (e.g., a volume within a combustion chamber or a fuel volume within which the nanoparticles are distributed), and V_{Total}−V_{particles} represents a volume in between the nanoparticles. In some embodiments, a packing density of nanoparticles is desirably at least about 10⁻⁵ (or at least about 0.001%), such as at least about 10⁻⁴ (or at least about 0.01%), at least about 10⁻³ (or at least about 0.1%), or at least about 10⁻² (or at least about 1%), and up to about 5×10⁻² (or up to about 5%), up to about 10⁻¹ (or up to about 10%), or more.

Examples of applications of the optical ignition technique described herein include the incorporation of optical ignition systems in combustion engines, such as those found in cars, power plants, aircrafts, and rockets; power generators in MEMS, such as for the purposes of sensors or actuators; and reaction devices, such as explosive devices for the purposes of demolition or weaponry. For example, rapid reciprocating engines and jet engines, such as air breathing jet engines, gas turbines, turbojet engines, turbofan engines, turboprop engines, prop fan engines, ramjet engines, and scramjet engines, can benefit from the incorporation of optical ignition systems to reduce the time for combustion and achieve higher combustion efficiency. For certain applications, a total combustion time can be specified as the time duration to burn x % of an initial mass of a fuel injected into a combustion chamber, as measured from the completion of delivery of a pulse of optical energy, where x % can be specified as 90%, 95%, 98%, 99%, 99.5%, or 100%, and where the mass of the fuel can be measured by, for example, a pressure trace from an initial pressure (e.g., in the range of about 1 atm to about 4 atm) using a piezoelectric pressure transducer. In some embodiments, a total combustion time of a distributed, optical ignition system can be significantly shorter relative to the use of conventional, single-point ignition systems, and can be no greater than about 150 ms, such as no greater than about 120 ms, no greater than about 100 ms, no greater than about 80 ms, no greater than about 60 ms, no greater than about 40 ms, or no greater than about 20 ms, and down to about 10 ms, down to about 5 ms, down to about 1 ms, or less. Optical ignition systems can provide additional advantages, such as lower cost and lower input power than conventional spark igniters. In addition, the optical ignition systems can be readily installed in a variety of combustion chambers, and can provide distributed ignition of fuels without requiring extreme high pressure or temperature.

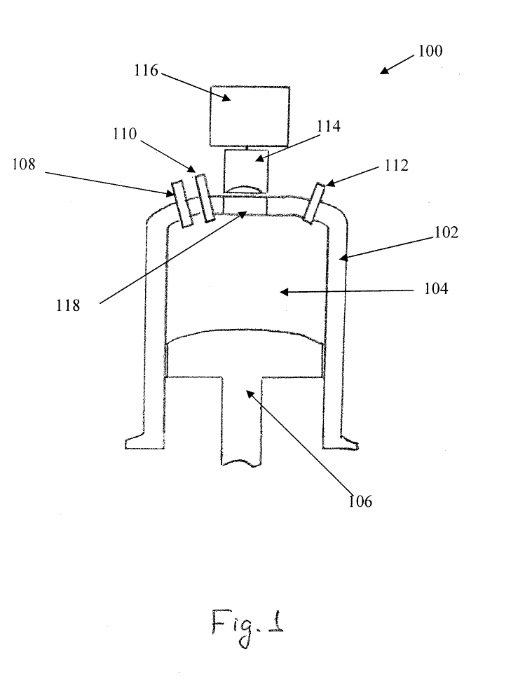

Attention turns to FIG. 1, which illustrates a reciprocating engine 100 implemented in accordance with an embodiment of the invention. The engine 100 includes a housing 102, which defines a combustion chamber 104, and a piston 106, which is disposed within and is slidingly engaged with the housing 102 to allow up and down, reciprocating movement of the piston 106. As illustrated in FIG. 1, a set of injection mechanisms 108 and 110 are connected to and extend through the housing 102 to introduce a fuel and a set of nanoparticles into the combustion chamber 104, and an exhaust mechanism 112 is connected to and extend through the housing 102 to remove combustion gases or other products from the combustion chamber 104. The injection mecha nisms 108 and 110 and the exhaust mechanism 112 can be implemented using, for example, valves, camshafts, nozzles, or a combination thereof. Although the separate injection mechanisms 108 and 110 are illustrated in FIG. 1 to respectively introduce the fuel and the nanoparticles, it is contemplated that the fuel and the nanoparticles can be pre-mixed, and can be introduced into the combustion chamber 104 through a common injection mechanism.

In the illustrated embodiment, the engine 100 includes an optical ignition system, which includes an optical source 114 and a controller 116, which is connected to the optical source 114 and coordinates operation of the optical source 114 relative to the other components of the engine 100. The controller 116 can be implemented in hardware, software, or a combination of hardware and software. Upon injection of the fuel and the nanoparticles into the combustion chamber 104, the controller 116 activates the optical source 114, which irradiates the nanoparticles through an optical window 118 included in, or otherwise connected to, the housing 102 and, thereby, ignites the fuel in a distributed fashion. Resulting combustion products expand and push the piston 106 downwardly, and removal of the combustion products from the combustion chamber 104 allow upward movement of the piston 106 back to its initial position. Various aspects of the optical ignition system illustrated in FIG. 1 can be implemented as explained in the introductory passages above, and, therefore, are not repeated. It is contemplated that an internal surface of the housing 102 defining the combustion chamber 104 can be implemented as a reflective surface to enhance efficiency of optical ignition through scattering or other effects.

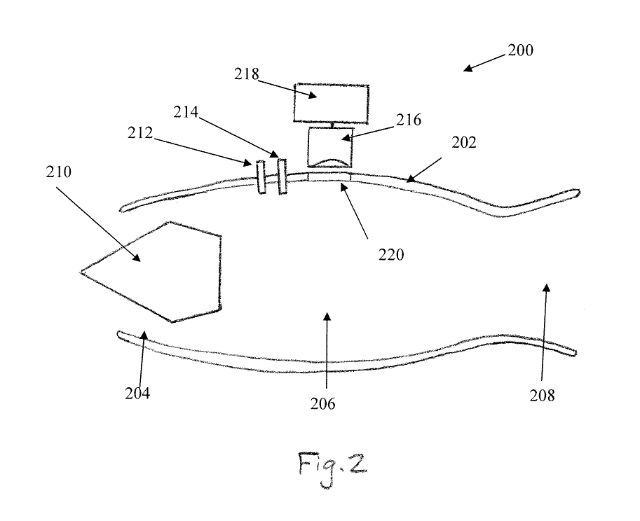

Attention next turns to FIG. 2, which illustrates a jet engine 200 implemented in accordance with another embodiment of the invention. The engine 200 includes a housing 202, which defines three sections, namely an inlet 204 to compress incoming air, a combustion chamber (or combustor) 206 to inject a fuel and a set of nanoparticles and combust the fuel, and a nozzle 208 to expel combustion products and produce thrust. An inlet body 210 is disposed within the housing 202 and at least partially extends through the inlet 204 to aid in the compression and to direct the flow of incoming air. As illustrated in FIG. 2, a set of injection mechanisms 212 and 214 are connected to and extend through the housing 202 to introduce the fuel and the nanoparticles into the combustion chamber 206. Although the separate injection mechanisms 212 and 214 are illustrated in FIG. 2 to respectively introduce the fuel and the nanoparticles, it is contemplated that the fuel and the nanoparticles can be pre-mixed, and can be introduced into the combustion chamber 206 through a common injection mechanism.

In the illustrated embodiment, the engine 200 includes an optical ignition system, which includes an optical source 216 and a controller 218, which is connected to the optical source 216 and coordinates operation of the optical source 216 relative to the other components of the engine 200. Upon injection of the fuel and the nanoparticles into the combustion chamber 206, the controller 218 activates the optical source 216, which irradiates the nanoparticles through an optical window 220 included in, or otherwise connected to, the housing 202 and, thereby, ignites the fuel in a distributed fashion. Resulting combustion products are expelled through the nozzle 208, thereby producing thrust. Various aspects of the engine 200 and the optical ignition system illustrated in FIG. 2 can be implemented as explained in the introductory passages and in connection with FIG. 1 above, and, therefore, are not repeated. It is contemplated that an internal surface of the housing 202 defining the combustion chamber 206 can be implemented as a reflective surface to enhance efficiency of optical ignition through scattering or other effects.

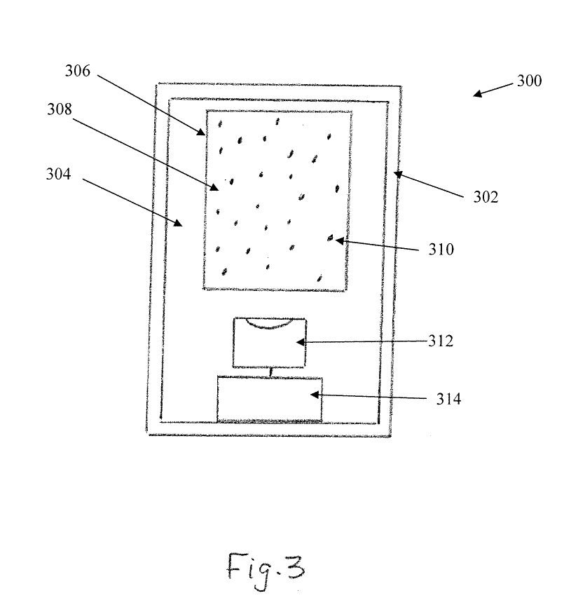

FIG. 3 illustrates a reaction device 300 that is implemented in accordance with yet another embodiment of the invention. The device 300 is implemented as an explosive device, and includes a housing 302, which defines an internal chamber 304 within which a reaction material 306 is disposed. In the illustrated embodiment, the reaction material 306 is implemented in a pellet form, and includes a substantially optically transparent fuel 308 and a set of nanoparticles 310 dispersed within the fuel 308. Also disposed within the internal chamber 304 is an optical ignition system, which includes an optical source 312 and a controller 314, which is connected to the optical source 312 and coordinates operation of the optical source 312 to ignite the fuel 308 and trigger detonation of the device 300. At a specified or user-selectable time, the controller 314 activates the optical source 312, which irradiates the nanoparticles 310 dispersed within the fuel 308, thereby igniting the fuel 308 in a distributed fashion. Various aspects of the device 300 and the optical ignition system illustrated in FIG. 3 can be implemented as explained in the introductory passages and in connection with FIG. 1 and FIG. 2 above, and, therefore, are not repeated. It is contemplated that an internal surface of the housing 302 defining the internal chamber 304 can be implemented as a reflective surface to enhance efficiency of optical ignition through scattering or other effects. It is also contemplated that the optical ignition system can be disposed outside of the housing 302, and can irradiate the reaction material 306 through an opening or optical window included in, or otherwise connected to, the housing 302.

### EXAMPLES

### Experimental

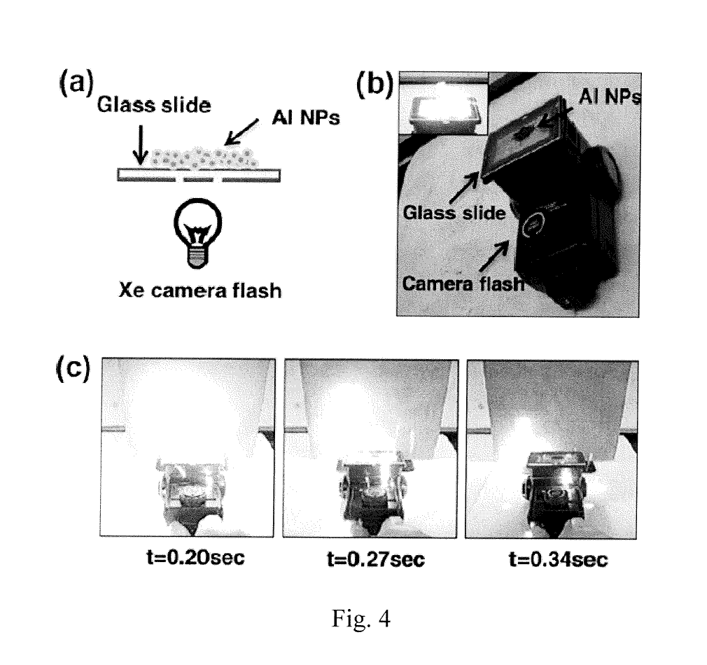

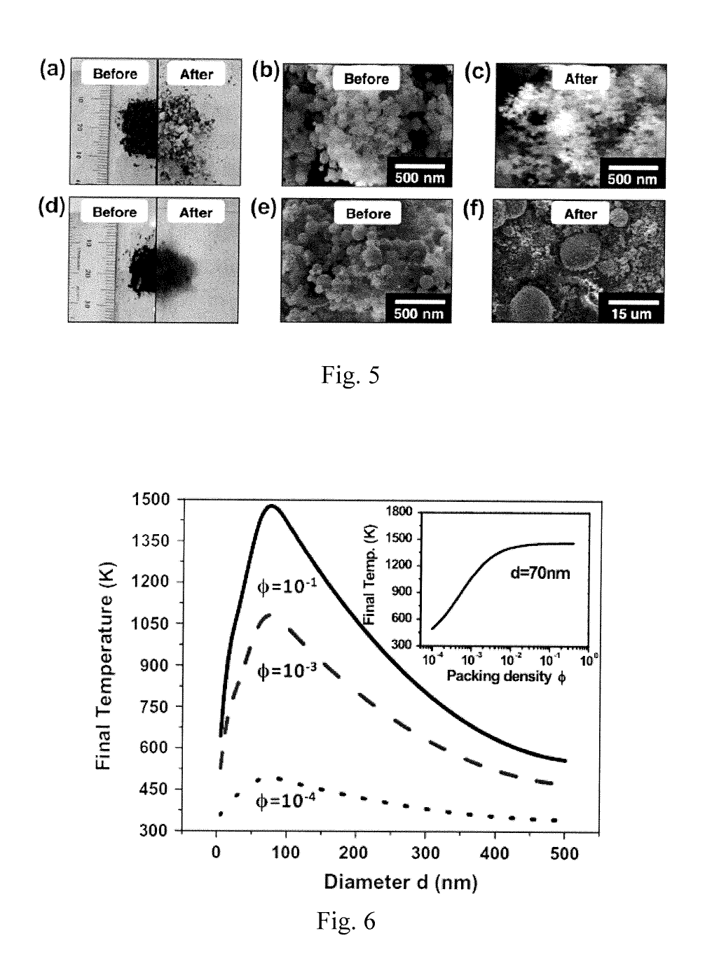

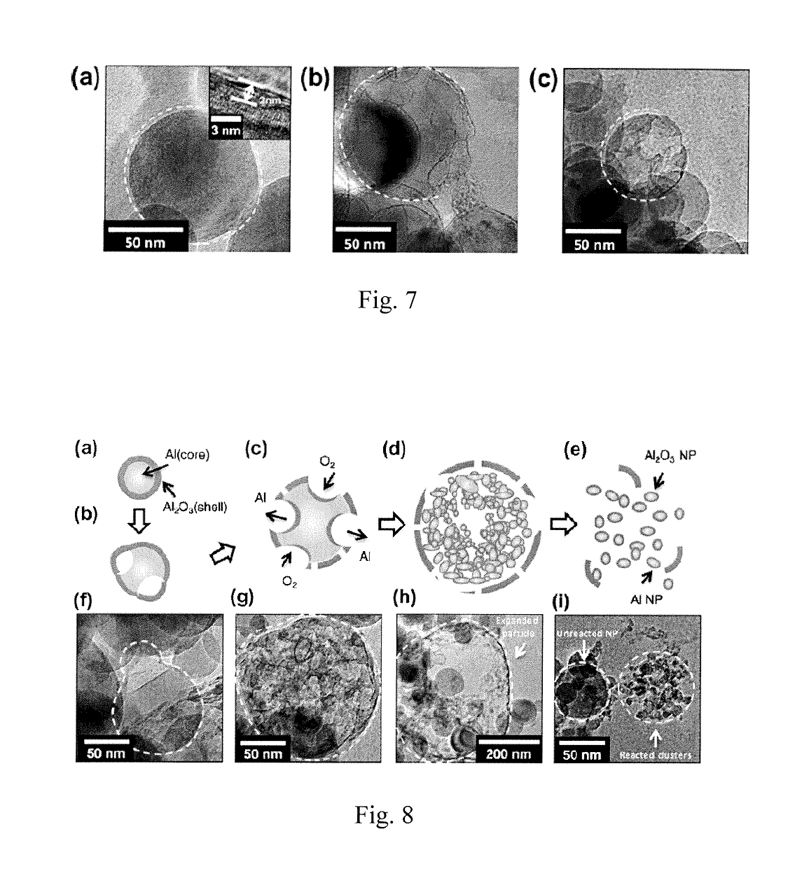

Flash ignition of Al nanoparticles is achieved using a commercial camera flash unit (Vivitar 285 HV), which is equipped with a xenon lamp. The maximum energy density of the flash unit is estimated to be slightly above 620 mJ/cm². Specifically, tens of milligrams of Al nanoparticles (average diameter (d_{avg})=60-96 nm, size distribution: 10-300 nm, see Table 1, SkySpring International Inc.) were placed on top of a 1 mm thick glass slide that was located 2 cm above the xenon lamp in air. The Al nanoparticles are ignited by a single exposure of the camera flash unit (FIG. 4a and b), and the nanoparticles burn in air for about 10 s with a yellow glow (FIG. 4b, inset). The Al nanoparticles change from dark gray, loose powders to light gray, aggregated particles after combustion (FIG. 5a). The original Al nanoparticles are substantially spherical and highly agglomerated with an average diameter in the range of 60-96 nm (FIG. 5b) with a 2 nm thick native aluminum oxide layer (FIG. 7a), and, after flash ignition, the nanoparticles are oxidized into smaller nanoparticles (3-20 nm, FIG. 8i), which are agglomerated (FIG. 5c). It was found that successful flash ignition is not sensitive to the mass of Al nanoparticles in the range of 10-1,000 mg.

TABLE 1
Size distribution of Al nanoparticles

| Size interval (nm) | Mass Fraction % |
|---|---|
| 10-18 | 12.9 |
| 18-36 | 13.5 |
| 36-60 | 16.6 |
| 60-96 | 18.0 |
| 96-140 | 13.5 |
| 140-200 | 12.5 |
| 200-300 | 13.0 |

The flash ignition method can be applied to solid mixtures including Al nanoparticles, such as a stoichiometric mixture of Al nanoparticles and CuO nanoparticles (d_{avg}=60 nm, Inframat Advanced Materials). The thermite mixture was mixed by hand for 2 min, and the success of flash ignition was not sensitive to the degree of mixing. Once the Al ignites, the Al/CuO mixture reacts through the exothermic thermite reaction: 2Al+3CuO→Al₂O₃+3Cu. The thermite reaction, in contrast to the burning of pure Al in air, proceeds violently and lasts less than a few seconds (FIG. 4c). Following the reaction, the color of the thermite mixture turns from black into brown, indicating the formation of copper (FIG. 5d). The melting of copper during the reaction causes the products of the thermite reaction to agglomerate into larger, micron-sized particles (FIG. 5f).

Furthermore, the flash ignition method can be extended to the ignition of liquid and gaseous fuels (e.g., heptane, methane, and so forth) by the addition of Al nanoparticles if the particle surface is exposed to an oxidant (oxygen or metal oxide). In the case of heptane, a few drops of heptane (1 ml) were poured in a Buchner flask located 2 cm above the xenon lamp, and the Buchner flask was connected to a pipette with 10 mg of Al nanoparticles inside. The Al nanoparticles were injected from the pipette to the flask and ignited subsequently by flash, which ignites heptane at multiple locations. The ignition of heptane was accompanied by a pop sound, and kept burning until the heptane was consumed. For methane ignition, a mixture of methane and air was filled inside a one-side closed glass tube with an inner diameter of 35 mm and a length of 16 cm. Al nanoparticles (10 mg) were placed on top of the glass slide, and the open-side of the glass tube was placed on top of the glass slide. Upon exposure to the flash unit, the methane/air mixture was ignited at the bottom by the Al nanoparticles, and a laminar flame propagated across the tube while the Al nanoparticles were burning at the bottom of the tube. These experiments demonstrate a distributed, optical ignition technique that results in the ignition of solid phase energetic materials, liquid fuels, and gaseous fuels by the addition of Al nanoparticles.

It should be noted that flash ignition of Al nanoparticles was not observed when the nanoparticles were placed sparsely over the glass slide by drop casting the nanoparticles diluted with hexane onto the slide and then allowing the hexane to evaporate. Similarly, flash ignition of Al micron-sized particles (d_{avg}=20 μm, Sigma Aldrich) was not observed under any conditions. The results of the above experiments suggest that the packing density and the diameter of Al nanoparticles are important factors for successful flash ignition.

Estimation of the Temperature Increase of Single and Multiple Al Particles

To further investigate Al particle flash ignition, the temperature increase of Al particles by a single flash exposure was estimated. The flash ignition of Al nanoparticles is achieved by the photo-thermal effect, when the energy of the incident light absorbed by Al nanoparticles is sufficient to raise their temperatures beyond their ignition temperatures. The purpose of the calculation is to simulate the initial stage of flash ignition and to understand the qualitative dependence of temperature rise on the size and packing density of Al nanoparticles.

Estimation of the temperature increase of single Al particles: First, estimation was carried out for the temperature rise from room temperature (300 K) of single isolated particles when exposed to a flash unit. The spectrum of the camera flash unit is assumed to be a blackbody radiation at a temperature of 6,500 K, and the incident light intensity, I_{inc}, is about 1,000 W/cm² on the basis of an energy density of 1 J/cm² and a flash duration of 1 ms. The light absorption by the Al₂O₃ shell is neglected, since Al₂O₃ is substantially optically transparent. Since Al has a high thermal conductivity, the temperature distribution inside the Al particle is assumed to be constant. The temperature rise of Al particles is estimated by using the heat transfer equations of a single sphere of radius R embedded in homogeneous air, where the heat source term comes from the energy absorption rate of Al nanoparticles by the incident flash light:

$$\begin{matrix}{C}_{p , Al} {ρ}_{Al} \frac{\partial {T}_{Al} ( t )}{\partial t} + 4 π {R}^{2} G [ {T}_{Al} ( t ) - {T}_{air} ( t , r = R ) ] = P , & ( 1 ) \\ {C}_{p , air} {ρ}_{air} \frac{\partial {T}_{air} ( t , r )}{\partial t} - K {∇}^{2} {T}_{air} ( t , r ) = 0 , & ( 2 )\end{matrix}$$

and the boundary condition is

$$K \frac{\partial {T}_{air} ( t , r )}{\partial r} {\vert}_{r = R } = G [ {T}_{air} ( t , r = R ) - {T}_{Al} ( t ) ] , \qquad ( 3 )$$

In the above equations, C_{p,air}, C_{p,Al}, and ρₐᵢᵣ, ρ_{Al} are specific heat (J/kg K) and the density (kg/m³) of air and Al respectively. V_{Al} is the volume of Al; R is the radius of the particle; G is the surface conductance between the Al particle and air (MW/m² K); P is the total energy absorption rate per particle (W); and K is the thermal conductivity of air (W/mK). A finite G represents a temperature discontinuity between the interface of the particle and air. Solving for the above equations, in the limit of t→∞, the maximum temperature rise of a single particle is given by:

$$Δ {T}_{Al , max} = \frac{P}{4 π {R}^{2}} ( \frac{1}{G} + \frac{R}{K} ) , \qquad ( 4 )$$

In Equation (4), ΔT_{Al,max} is the maximum temperature increase of the particle. Although the surface conductance G between the particles and air can vary from 10 to 1,000 MW/m² K, the corresponding final temperature differs by a modest amount of 0.1 K. Hence, the contribution of G to the temperature rise in Equation (4) can be neglected. P is the total energy absorption rate per particle (W), which is calculated by integrating over the specific energy absorption rate over all the wavelengths λ, ranging from 185 nm to 2,000 nm and corrected with the emissivity factor (ε=I_{inc}/σT⁴), as shown in:

$$P = \frac{{I}_{Inc .}}{σ {T}^{4}} \int \frac{1}{{λ}^{5}} \frac{4 {π}^{2} {c}^{2} ℏ}{exp [ 2 π c ℏ / ( λ {k}_{B} T ) ] - 1} {C}_{abs} ( λ ) d λ , \qquad ( 5 )$$

In Equation (5), σ is the Stefan-Boltzmann constant; c is the speed of light; h is the reduced Planck constant, and k_{B} is the Boltzmann constant. The specific energy absorption rate at a specific wavelength is the product of the absorption cross-section, C_{abs}(λ), and the intensity of the incident light at the wavelength. The absorption cross-section C_{abs}(λ) was calculated by using a Mie theory calculator, namely a “Mieplot.”

The estimated temperature rise of single Al particles with diameters of 70 nm and 20 μM are 0.18 K and 197 K respectively, and both final temperatures are much lower than the typical ignition temperature of Al nanoparticles, which ranges from about 833 K to the melt ing point of Al (933 K). This result is consistent with the experimental observation that sparsely dispersed Al nanoparticles and micron-sized particles are not ignited by a camera flash.

Estimation of the temperature increase of multiple Al particles: To consider the effect of multiple Al particles, the packing density is specified as φ=V_{Al}/Vₐᵢᵣ, i.e., the volume ratio of Al particles to the confined air among the particles. The temperature rise of Al particles was estimated by assuming that the energy absorbed by the Al particles is used to heat up the particles and the confined air:

(ρₐᵢᵣVₐᵢᵣC_{p,air}+ρ_{Al}V_{Al}c_{p,Al})ΔT=pV_{Al}Δt, (6)

$$Δ T = \frac{p Δ t}{\frac{{ρ}_{air} {c}_{p , air}}{φ} + {ρ}_{Al} {c}_{p , Al}} , \qquad ( 7 )$$

where p is the energy absorption rate per unit volume (W/m³) by Al, and Δt is the flash duration(s). Here for estimation purpose, it is assumed that the Al and air have the same temperature rise, although the actual temperature of Al is expected to be higher than that of air. The estimation also neglected optical interactions among Al nanoparticles and the possible air expansion between Al nanoparticles due to the heating. It should be noted that the estimation presented here is not intended as a rigorous flash heating model, which would account for the Al nanoparticle distribution and interfacial heat conductivity. Rather, the purpose of the estimation is to provide qualitative information on the dependence of temperature rise on the size and packing density of Al nanoparticles.

FIG. 6 shows the dependence of the temperature rise of the Al particles on their sizes and packing densities. First, the largest temperature rise is expected for nanoparticles with about 75 nm in diameter, regardless of the packing density. As the size of the Al particles increases beyond 75 nm, the temperature rise decreases because the particles scatter more and absorb less energy. In addition, larger micron-sized Al particles involve much higher ignition temperatures of above 1,200 K. Hence, Al microparticles are not readily ignited by a flash unit. Second, there is a threshold Al packing density to achieve flash ignition because, for Al particles of the same diameter, their temperature rise increases sharply with the Al packing density and eventually saturates when the packing density is roughly above 1% (FIG. 6, inset). A higher temperature rise is expected for higher packing densities of Al particles since more heat per unit volume is absorbed. In summary, successful flash ignition of Al nanoparticles relies on two parameters: their diameters and their packing densities. Finally, it should be noted that the absorption cross-section of Al nanoparticles peaks at different wavelengths for Al nanoparticles of different diameters, so it is desirable for an optical source to have a broad spectrum emission to ignite the Al nanoparticles having different diameters. For this reason, flash light can be more advantageous than lasers for igniting Al nanoparticles.

Al Nanoparticle Oxidation Mechanism

The oxidation mechanism of Al nanoparticles ignited by a camera flash unit is investigated. Al nanoparticles ignited by the flash unit are expected to be oxidized by the MDM due to the large heating rate, namley on the order of 10⁶ K/s or higher. To verify the MDM oxidation, Al nanoparticles were first exposed to the flash unit in an inert Ar gas to avoid further oxidation. Al nanoparticles (10 mg) were placed inside a Buchner flask filled with Ar gas. The xenon flash lamp was placed 2 cm below the Buchner flask. The flash unit was triggered ten times with an interval of 10 s. During the flash exposure, no ignition was observed, and the remaining Al nanoparticles were collected for TEM characterization. The TEM images (FIG. 7a and inset) show that Al nanoparticles have average diameters of 60-96 nm and roughly 2 nm thick Al₂O₃ shells before the flash exposure. After the flash exposure, the Al₂O₃ shell is partially ruptured, and the molten Al is dispersed out of the shell (FIG. 7b and c). This observation suggests that the flash unit provided enough energy to melt the Al and generated a large dynamic pressure inside the nanoparticle to rupture its shell, and eventually led to the outflow of the molten Al.

The oxidation process of Al nanoparticles in air is studied by examining multiple nanoparticles after flash exposure using TEM. Due to the spatial non-uniformity of the flash light intensity and the packing density of Al nanoparticles, the nanoparticles are expected to have different temperature rise and exposure to oxygen, so their oxidation process will quench at different stages after the flash exposure. Therefore, by examining multiple Al nanoparticles, the oxidation process can be re-constructed as illustrated in FIG. 8. Initially, similar to the case in Ar, Al melts upon exposure to the flash unit, which pushes the oxide shell outwards (FIG. 8b and f). When the pressure rise associated with the melting of Al is large enough, it ruptures certain regions of the oxide shell, and the molten Al flows out (FIG. 8c and g). Subsequently, Al and oxygen come in contact with each other and react exothermically. The heat generated further causes more Al to melt or even evaporate, which pushes the oxide shell further out, and the original Al nanoparticle has grown from less than 100 nm to over 300 nm in diameter (FIG. 8d and h). As shown in FIG. 8h, the big hollow sphere corresponds to the expanded Al particle. Eventually, the entire particle fractures and breaks into clusters of 3-20 nm, much smaller than the original Al nanoparticles (FIG. 8e and i). The resulting clusters include both Al₂O₃ particles and partially oxidized Al particles. These observations suggest that the Al nanoparticles ignited by the flash unit are oxidized by the MDM.

While the invention has been described with reference to the specific embodiments thereof, it should be understood by those skilled in the art that various changes may be made and equivalents may be substituted without departing from the true spirit and scope of the invention as defined by the appended claim(s). In addition, many modifications may be made to adapt a particular situation, material, composition of matter, method, or process to the objective, spirit and scope of the invention. All such modifications are intended to be within the scope of the claim(s) appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. An engine comprising:
a housing defining a combustion chamber;
a set of injection mechanisms connected to the housing and configured to introduce a fuel and nanoparticles into the combustion chamber; and
an optical ignition system connected to the housing and configured to irradiate the nanoparticles to ignite the fuel.

2. The engine of claim 1, wherein the nanoparticles include at least one of a metal and a metal oxide.

3. The engine of claim 2, wherein the nanoparticles include aluminum nanoparticles.

4. The engine of claim 3, wherein the aluminum nanoparticles each include a core including aluminum and a shell surrounding the core and including aluminum oxide.

5. The engine of claim 1, wherein the optical ignition system includes an optical source configured to irradiate the nanoparticles at an energy density in the range of 0.1 J/cm² to 50 J/cm² and a pulse duration in the range of 0.1 ms to 50 ms.

6. A reaction device comprising:
a housing defining an internal chamber;
a reaction material disposed within the housing and including a fuel and nanoparticles dispersed within the fuel; and
an optical ignition system connected to the housing and configured to irradiate the nanoparticles to ignite the fuel.

7. The reaction device of claim 6, wherein the nanoparticles have a size that is no greater than 300 nm.

8. The reaction device of claim 6, wherein the size of the nanoparticles is no greater than 200 nm.

9. The reaction device of claim 6, wherein a packing density of the nanoparticles within the fuel is at least 10⁻⁴.

10. The reaction device of claim 9, wherein the packing density of the nanoparticles within the fuel is at least 10⁻³.
